(19) United States
(12) Patent Application Publication
(10) Pub. No.: US 2004/0046989 A1
(43) Pub. Date: Mar. 11, 2004

(54) Printing management apparatus and printing management method

(75) Inventor: Hironori Matsugi, Nagano-ken (JP)

Correspondence Address: SUGHRUE MION, PLLC, 2100 PENNSYLVANIA AVENUE, N.W., WASHINGTON, DC, 20037, US

(73) Assignee: SEIKO EPSON CORPORATION

(21) Appl. No.: 10/449,693

(22) Filed: Jun. 2, 2003

(30) Foreign Application Priority Data
May 31, 2002 (JP) 2002-159313
May 28, 2003 (JP) 2003-151530

(51) Int. Cl. B41J 1/00

(52) U.S. Cl. 358/1.15

(57) ABSTRACT

A printing management apparatus 30 reads data, such as a paper consumption, from each of multiple printing devices 50a and 50b at regular time intervals. An instruction for printing a preset test pattern image is given to each object printing device, when a certain condition is fulfilled, for example, when at least a preset time period has elapsed since a latest instruction for printing the test pattern image was given to the object printing device. The printing management apparatus 30 receives image data, which has been printed by the object printing device in response to the instruction and has been read by a scanner connecting with the object printing device, from the object printing device. The printing management apparatus 30 compares the received image data with original data of the test pattern image registered in a printing execution database 34 to check for abnormality of printing. Maintenance data according to a result of the check is output to a jurisdiction management server 40 that manages maintenance of the object printing device.

### BACKGROUND OF THE INVENTION

1. Field of the Invention

The present invention relates to a printing management apparatus and a printing management method. More specifically the invention pertains to a printing management apparatus that is connected with multiple printing devices for printing images via a network and manages the multiple printing devices through transmission of information via the network, as well as to a corresponding printing management method.

2. Description of the Prior Art

A proposed printing management apparatus is connected with multiple printing devices via a network and transmits information, for example, a paper consumption, to and from each of the multiple printing devices via the network, thus attaining management of the individual printing devices. This prior art printing management apparatus obtains use information, such as the paper consumption of each printing device, and contributes the use information to calculation of charges for the respective printing devices.

The prior art printing management apparatus, however, does not take into account the quality of printing by each of the printing devices. This results in only insufficient management of the printing devices.

### SUMMARY OF THE INVENTION

The object of the present invention is thus to remove the drawbacks of the prior art technique and to provide a printing management apparatus and a corresponding printing management method that attain auto check for quality of printing by each of multiple printing devices and thereby ensure adequate management of the multiple printing devices.

In order to achieve above object, a printing management apparatus and a corresponding printing management method of the present invention are structured as follows.

A first printing management apparatus of the present invention is an apparatus that is connected with multiple printing devices, each of which is used to print an image, via a network and manages the multiple printing devices through transmission of information via the network, the printing management apparatus including: a memory unit that stores identification information on each of the multiple printing devices mapped to timing information on a timing of giving an instruction for printing a predetermined image to each of the multiple printing devices; a printing instruction transmission module that transmits printing instruction information, which represents the instruction for printing the predetermined image, at a timing specified by a specific piece of the timing information stored in the memory unit via the network to an object printing device identified by a piece of the identification information mapped to the specific piece of the timing information; a printing result reception module that receives a printing result, which is printed by the object printing device receiving the printing instruction information and is input by an image input device connecting with the object printing device, as image data via the network from the object printing device; and an abnormality check module that checks for abnormality of printing by the object printing device, based on the received image data.

The first printing management apparatus of the present invention provides the memory unit that maps identification information on each of the multiple printing devices connected with the printing management apparatus via the network to timing information on a timing of giving the instruction for printing the predetermined image to each of the multiple printing devices and stores the mapping. The printing management apparatus transmits the printing instruction information, which represents the instruction for printing the predetermined image, at a timing specified by a specific piece of the timing information stored in the memory unit via the network to an object printing device identified by a piece of the identification information mapped to the specific piece of the timing information. The printing management apparatus receives a printing result, which is printed by the object printing device receiving the printing instruction information and is input by an image input device connecting with the object printing device, as image data via the network from the object printing device, and checks for abnormality of printing by the object printing device, based on the received image data. In this structure of the invention, the instruction for printing the predetermined image is given to the object printing device at the timing specified by the specific piece of the timing information. The printing management apparatus receives the image data representing the printing result printed by the object printing device in response to the given instruction and checks for abnormality of printing by the object printing device. This arrangement attains auto check for abnormality of printing by each of the multiple printing devices and thus ensures adequate management of the multiple printing devices.

In the first printing management apparatus of the present invention, as one aspect, the memory unit may store original data of the predetermined image, and the abnormality check module may check for abnormality of printing, based on the received image data and the original data stored in the memory unit.

The first printing management apparatus of the invention, as another aspect, may further include an output setting information reception module that receives output setting information on an output setting of the object printing device for printing the predetermined image via the network from the object printing device, and in the first printing management apparatus of the invention, the abnormality check module may check for abnormality of printing, based on the image data received by the printing result reception module and the output setting information received by the output setting information reception module. In this case, the first printing management apparatus of the invention may further include a tolerance setting module that specifies a tolerance of deviation from original data of the predetermined image, based on the output setting information received by the output setting information reception module, and in the first printing management apparatus, the memory unit may further store the original data of the predetermined image, and the abnormality check module may determine whether the image data received by the printing result reception module is within the specified tolerance of deviation from the original data. Here, the output setting information may be information on setting of an output resolution.

The first printing management apparatus of the invention, as still another aspect, may include an input setting information reception module that receives input setting information on an input setting of the image input device for inputting the predetermined image printed by the object printing device via the network from the object printing device, and in the first printing management apparatus of the invention, the abnormality check module may check for abnormality of printing, based on the image data received by the printing result reception module and the input setting information received by the input setting information reception module. In this case, the first printing management apparatus may further include a tolerance setting module that specifies a tolerance of deviation from original data of the predetermined image, based on the input setting information received by the input setting information reception module, and in the first printing management apparatus the memory unit may further store the original data of the predetermined image, and the abnormality check module may determine whether the image data received by the printing result reception module is within the specified tolerance of deviation from the original data. Here, the input setting information may be information on setting of an input resolution.

In the first printing management apparatus of the invention, as still another aspect, the memory unit may further store information including a reference time, which is updated at a preset timing, as the timing information, and the printing instruction transmission module may transmit the printing instruction information when a preset time period has elapsed since a latest reference time stored in the memory unit. Here, the memory unit may store information including a latest time, when printing of the predetermined image was executed by the object printing device, as the timing information or a latest time, when general printing was executed by the object printing device, as the timing information.

The first printing management apparatus of the invention, as still another aspect, may further include a use information reception module that receives use information on use of the object printing device, from the object printing device, and in the first printing management apparatus of the invention, the memory unit may store the received use information mapped to identification information of the object printing device, which has sent the use information, and the printing instruction transmission module may transmit the printing instruction information to the object printing device identified by the identification information, which is mapped to the use information and the timing information stored in the memory unit, based on the use information and the timing information. In this case, the memory unit may store information including a latest time, when printing of the predetermined image was executed by the object printing device, as the timing information, and the use information reception module may receive a total printing volume of the object printing device since the stored latest time as the use information. Further, in this case, the printing instruction transmission module may transmit the printing instruction information to the object printing device, when the total printing volume of the object printing device since the latest time stored in the memory unit has reached a preset level.

The first printing management apparatus of the invention, as still another aspect, may include a check result notification module that notifies a result of the check carried out by the abnormality check module.

The first printing management apparatus of the invention, as still another aspect, may further include a maintenance instruction output module that outputs a maintenance instruction on maintenance of the object printing device, according to a result of the check for abnormality of printing by the printing device, which is carried out by the abnormality check module.

The first printing management apparatus of the invention, as still another aspect, may further include a stop instruction output module that outputs a stop instruction on a stop of printing to the object printing device, when the abnormality check module detects abnormality of the object printing device.

A second printing management apparatus of the present invention is an apparatus that is connected with multiple printing devices, each of which is used to print an image, via a network and manages the multiple printing devices through transmission of information via the network, the printing management apparatus including: a printing instruction module that gives an instruction for printing a predetermined image to an object printing device; a printing result acquisition module that acquires a printing result, which is printed by the object printing device receiving the instruction and is input by an image input device connecting with the object printing device, as image data from the object printing device; and an abnormality check module that checks for abnormality of printing by the object printing device, based on the acquired image data.

The second printing management apparatus of the present invention gives the instruction for printing the predetermined image to an object printing device, acquires a printing result, which is printed by the object printing device receiving the instruction and is input by an image input device connecting with the object printing device, as image data from the object printing device, and checks for abnormality of printing by the object printing device, based on the acquired image data. This arrangement attains auto check for quality of printing by the object printing device, based on the image data or the printing result of the predetermined image printed by the object printing device and input by the image input device.

In the second printing management apparatus of the invention, as one aspect, the abnormality check module may check for abnormality of printing, based on the acquired image data and original data of the predetermined image.

The second printing management apparatus of the invention, as another aspect, may further include an output setting information acquisition module that acquires output setting information on an output setting of the object printing device for printing the predetermined image via the network from the object printing device, and in the second printing management apparatus of the invention, the abnormality check module may check for abnormality of printing, based on the image data acquired by the printing result acquisition module and the output setting information acquired by the output setting information acquisition module. In this case, the second printing management apparatus of the invention may further include a tolerance setting module that specifies a tolerance of deviation from original data of the predetermined image, based on the output setting information acquired by the output setting information acquisition module, and in the second printing management apparatus of the invention, the abnormality check module may determine whether the image data acquired by the printing result acquisition module is within the specified tolerance of deviation from the original data. Here, the output setting information may be information on setting of an output resolution.

The second printing management apparatus of the invention, as still another aspect, may further include an input setting information acquisition module that acquires input setting information on an input setting of the image input device for inputting the printing result of the predetermined image printed by the object printing device via the network from the object printing device, and in the second printing management apparatus of the invention, the abnormality check module may check for abnormality of printing, based on the image data acquired by the printing result acquisition module and the input setting information acquired by the input setting information acquisition module. In this case, the second printing management apparatus of the invention may further include a tolerance setting module that specifies a tolerance of deviation from original data of the predetermined image, based on the input setting information acquired by the input setting information acquisition module, and in the second printing management apparatus of the invention, the abnormality check module may determine whether the image data acquired by the printing result acquisition module is within the specified tolerance of deviation from the original data. Here, the input setting information may be information on setting of an input resolution.

The technique of the invention is not restricted to the printing management apparatus discussed above, but is also applicable to a printing management method.

### BRIEF DESCRIPTION OF THE DRAWINGS

FIG. 1 schematically illustrates the structure of a printing management system 20 including a printing management apparatus 30 in one embodiment of the present invention;

FIG. 2 is a flowchart showing an information input routine executed by the printing management apparatus 30 of the embodiment;

FIG. 3 shows one example of the expendable consumption data;

FIG. 4 shows one example of the printing execution data;

FIG. 5 is a flowchart showing a test printing instruction routine executed by the printing management apparatus 30 of the embodiment;

FIG. 6 is a flowchart showing a print diagnosis routine executed by the printing management apparatus 30 of the embodiment;

FIG. 7 is a flowchart showing a printing abnormality check routine;

FIG. 8 shows an example of a nozzle clogging test pattern image; and

FIG. 9 shows one example of a head position deviation test pattern image.

### DESCRIPTION OF THE PREFERRED EMBODIMENTS

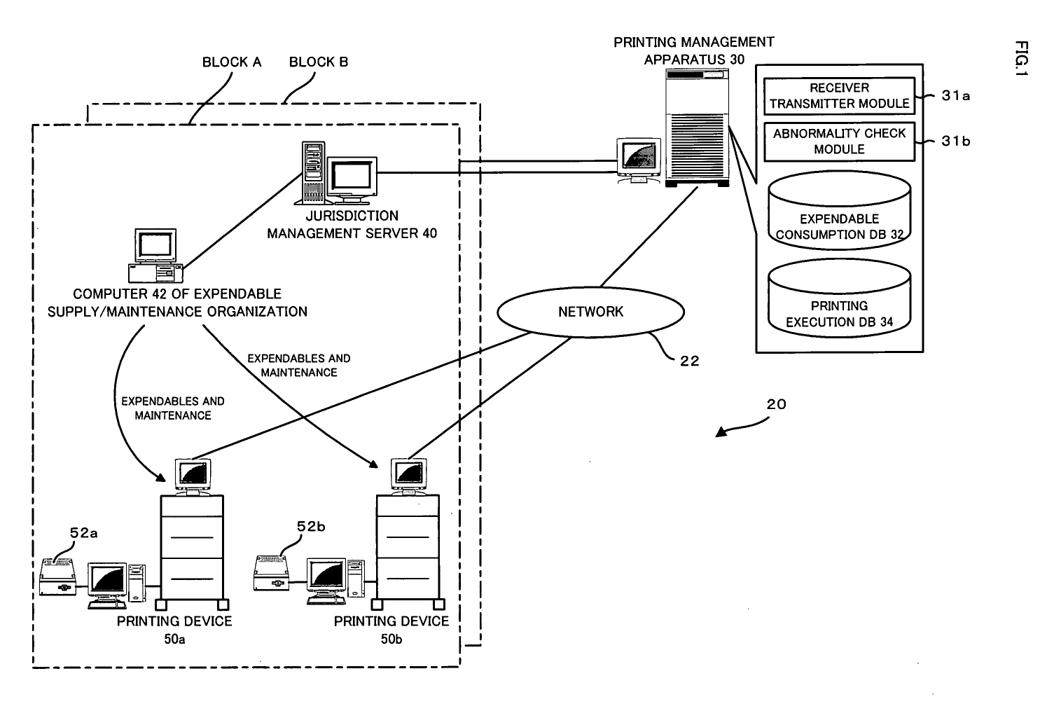

A preferred embodiment of the present invention is discussed below. FIG. 1 schematically illustrates the structure of a printing management system 20 including a printing management apparatus 30 in one embodiment of the invention. As illustrated, the printing management apparatus 30 of the embodiment is constructed as a network server of a single or multiple computers. The printing management apparatus 30 has functions of a, printing management server that acquires data regarding consumption of expendables (hereafter referred to as expendable consumption data) and data regarding execution of printing (hereafter referred to as printing execution data) from multiple printing devices 50a and 50b, which connect with the printing management apparatus 30 via a network 22, at regular intervals and transfers the acquired expendable consumption data to a jurisdiction management server 40, which manages supplies of expendables to the multiple printing devices 50a and 50b and maintenance of the multiple printing devices 50a and 50b. The printing management apparatus 30 also functions to give an instruction for printing a preset test pattern image for the purpose of checking the printing quality to each of the printing devices 50a and 50b based on the printing execution data and to check for abnormality of printing by each printing device based on a printing result of the preset test pattern image by the corresponding printing device in response to the given instruction. The printing management apparatus 30 includes a single or multiple computers to attain such functions. The printing management apparatus 30 has a receiver transmitter module 31a that receives and transmits information via the network 22, an abnormality check module 31b that checks for abnormality of printing by each of the multiple printing devices 50a and 50b connected via the network 22, an expendable consumption database 32 that stores the expendable consumption data in the form of a database, and a printing execution database 34 that stores the printing execution data in the form of a database.

The jurisdiction management server 40 is installed in each jurisdictional region or block (a block A or a block B in the illustrated example) and functions to manage supplies of expendables to the printing devices 50a and 50b located at photo studios in each block, as well as maintenance of the printing devices 50a and 50b. The jurisdiction management server 40 outputs supply instructions and maintenance instructions to a computer 42 of an expendable supply/maintenance organization, so as to keep predetermined stocks of expendables including printing papers and inks at the respective photo studios based on the expendable consumption data transferred from the printing management apparatus 30 and to ensure execution of adequate maintenance of the printing devices 50a and 50b at the respective photo studios based on maintenance data transferred from the printing management apparatus 30.

Each of the printing devices 50a and 50b includes multiple ink jet printers, where each ink jet printer makes inks like pigment inks ejected from a number of nozzles to print an image on printing paper. Scanners 52a and 52b as image input devices to read and input the image printed on the printing paper as image data are connected respectively to the printing devices 50a and 50b. Each of the printing devices 50a and 50b transmits the image data input by the scanner 52a or 52b to the printing management apparatus 30 via the network 22. Each of the printing devices 50a and 50b is capable of printing a preset test pattern image to check for abnormality of printing, for example, clogging of ink or a displacement of the head position, in response to an instruction given by the information management apparatus 30 of the embodiment. Original data used for printing the preset test pattern image is stored in non-illustrated memories of the printing devices 50a and 50b in the embodiment.

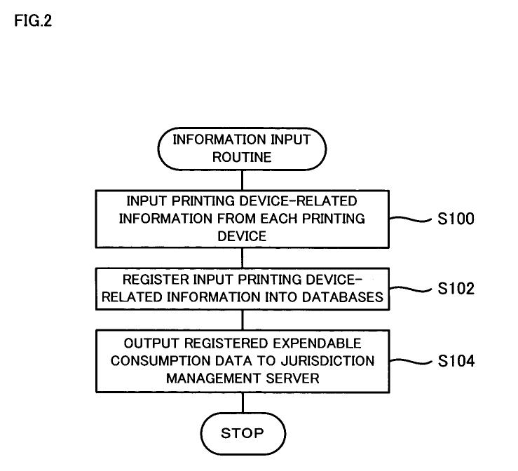

The printing management system 20 thus constructed carries out series of processing discussed below. FIG. 2 is a flowchart showing an information input routine executed by the printing management apparatus 30 of the embodiment. This information input routine is carried out iteratively at preset time intervals (for example, at every 12 hours). When the program enters the information input routine, the printing management apparatus 30 first inputs printing device-related information, which includes the expendable consumption data and the printing execution data described above, from each of the printing devices 50a and 50b in each block connecting with the printing management apparatus 30 via the network 22 (step S100), and registers the input expendable consumption data into the expendable consumption database 32 while registering the input printing execution data into the printing execution database 34 (step S102).

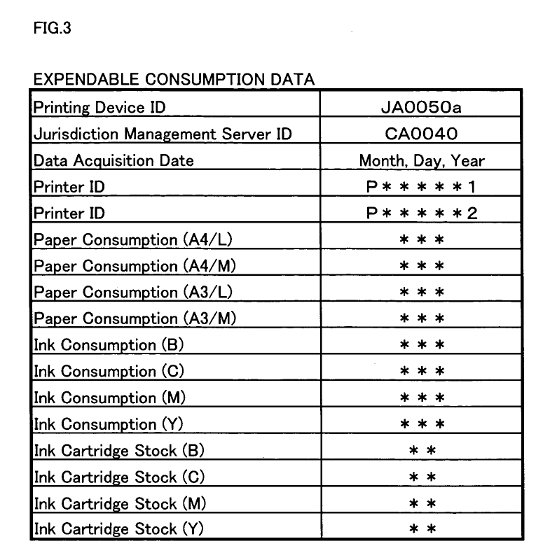

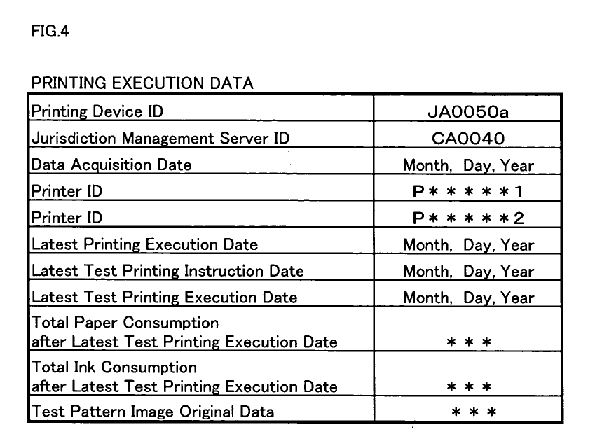

FIG. 3 shows one example of the expendable consumption data registered in the expendable consumption database 32, and FIG. 4 shows one example of the printing execution data registered in the printing execution database 34. As shown in FIG. 3, the expendable consumption data includes a ‘printing device ID’ as information for identifying each of the printing devices 50a and 50b, a ‘jurisdiction management server ID’ as information for identifying the jurisdiction management server 40 that has jurisdiction over the printing device 50a or 50b, a ‘data acquisition date’ representing the date when data is acquired from the printing device 50a or 50b, ‘printer IDs’ as information for identifying respective printers incorporated in the printing device 50a or 50b, ‘paper consumptions’ representing consumptions of respective printing papers, ‘ink consumptions’ representing consumptions of respective color inks, and ‘ink cartridge stocks’ representing stocks of ink cartridges of respective colors used for printing. The printing execution data, on the other hand, includes a ‘latest printing execution date’ representing a latest date when printing (general printing) is carried out by the corresponding printing device, a ‘latest test printing instruction date’ representing a latest date when an instruction for printing a test pattern image is given to the corresponding printing device, a ‘latest test printing execution date’ representing a latest date when printing of the test pattern image is carried out by the corresponding printing device, a ‘total paper consumption’ representing a total consumption of printing paper by the corresponding printing device after the ‘latest test printing execution date’, a ‘total ink consumption’ representing a total consumption of ink by the corresponding printing device after the ‘latest test printing execution date’, and ‘test pattern image original data’ that is identical with the original data of the test pattern image stored in the memory of the corresponding printing device, in addition to the ‘printing device ID’, the ‘jurisdiction management server ID’, the ‘data acquisition date’, and the ‘printer IDs’ discussed above. Among the printing execution data registered in the printing execution database 34, the ‘latest test printing instruction date’ is updated every time the printing management apparatus 30 of the embodiment gives an instruction for printing the test pattern image to the corresponding printing device. The ‘total paper consumption’ and the ‘total ink consumption’ are obtained by summing up the ‘paper consumptions’ and the ‘ink consumptions’ received from the corresponding printing device 50a or 50b after the ‘latest test printing execution date’.

After registration of the expendable consumption data and the printing execution data respectively into the expendable consumption database 32 and into the printing execution database 34, the expendable consumption data is output to the jurisdiction management server 40 (step S104). The program then exits from this information input routine. The jurisdiction management server 40 instructs the expendable supply/maintenance organization located in the jurisdictional block to supply required expendables to the respective printing devices 50a and 50b, based on the input expendable consumption data.

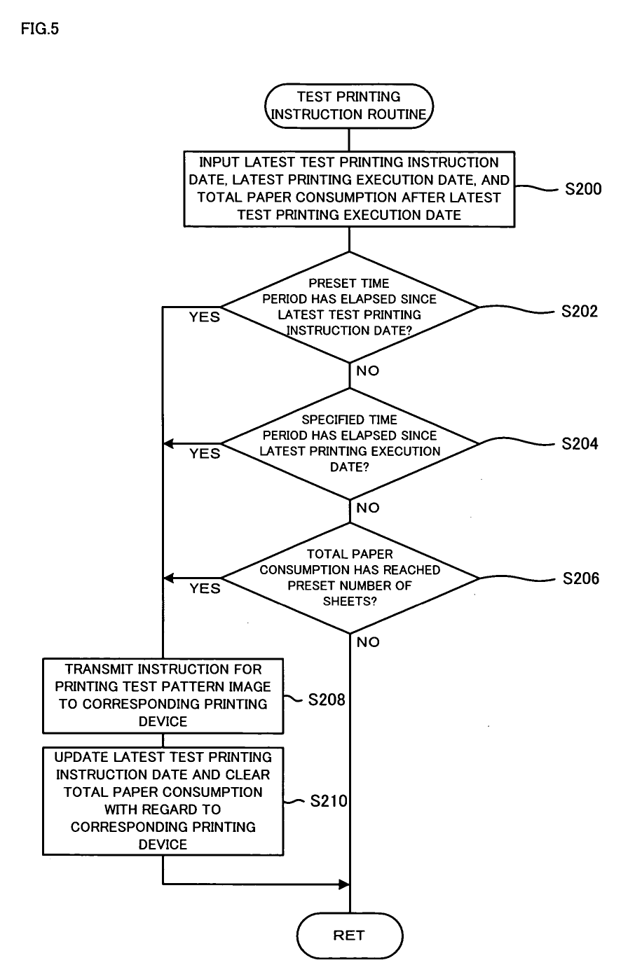

The following describes a series of processing executed by the printing management apparatus 30 of the embodiment based on the printing execution data, more specifically a series of processing to give an instruction for printing a preset test pattern image to each of the printing devices 50a and 50b. FIG. 5 is a flowchart showing a test printing instruction routine executed by the printing management apparatus 30 of the embodiment. This test printing instruction routine is repeatedly carried out at preset time intervals (for example, at every 24 hours). When the program enters this test printing instruction routine, the printing management apparatus 30 first extracts the ‘latest test printing instruction date’, the ‘latest printing execution date’, and the ‘total paper consumption after the latest test printing execution date’ from the printing execution data registered in the printing execution database 34 with regard to each of the printing devices 50a and 50b (each printing device ID) connected via the network 22 (step S200). It is then determined whether at least a preset time period (for example, at least 1 month) has elapsed since the ‘latest test printing instruction date’, that is, whether non-execution of printing the test pattern image has continued for at least the preset time period (step S202). It is also determined whether at least a specified time period (for example, at least 1 month) has elapsed since the ‘latest printing execution date’, that is, whether non-execution of general printing has continued for at least the specified time period (step S204). It is further determined whether the ‘total paper consumption after the latest test printing execution date’ has reached at least a preset number of sheets (for example, at least 100 sheets) (step S206). When none of the conditions is fulfilled, that is, when it is determined that the preset time period has not yet elapsed since the ‘latest test printing instruction date’, that the specified time period has not yet elapsed since the ‘latest printing execution date’, and that the ‘total paper consumption after the latest test printing execution date’ has not yet reached the preset number of sheets, there is no necessity of printing the test pattern image. The program thus immediately exits from the test printing instruction routine.

When any of the conditions is fulfilled, that is, when it is determined that the preset time period has elapsed since the ‘latest test printing instruction date’, that the specified time period has elapsed since the ‘latest printing execution date’, or that the ‘total paper consumption after the latest test printing execution date’ has reached the preset number of sheets, on the other hand, there is a necessity of printing the test pattern image. The printing management apparatus 30 accordingly transmits printing instruction data representing an instruction for printing the test pattern image to the corresponding printing device (step S208), and updates the ‘latest test printing instruction date’ to the current transmission date of the printing instruction data, while clearing the ‘total paper consumption after the latest test printing execution date’ to zero (step S210). The program then exits from this test printing instruction routine. The printing device receiving the printing instruction data reads the original data of the test pattern image stored in the built-in memory and prints the test pattern image on the printing paper. The printing device then reads the printed test pattern image with the scanner connected thereto and transmits this test pattern image as image data to the printing management apparatus 30 of the embodiment. The printing device also transmits setting data related to printing of the test pattern image (setting data on an output resolution of the printing device in the embodiment) and setting data related to reading of the test pattern image printed on the printing paper as image data (setting data on an input resolution of the scanner in the embodiment) to the printing management apparatus 30 of the embodiment. The printing management apparatus 30 of the embodiment waits for transmission of the image data, the setting data on the output resolution of the printing device, and the setting data on the input resolution of the scanner.

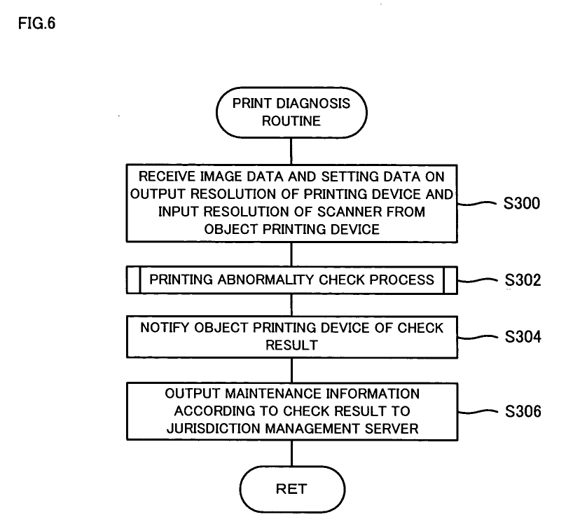

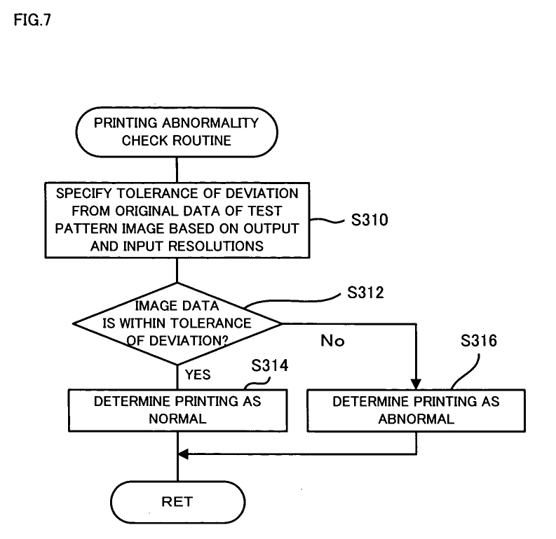

The following describes a series of processing executed by the printing management apparatus 30 of the embodiment, in response to transmission of the image data and the setting data on the input resolution and the output resolution. FIG. 6 is a flowchart showing a print diagnosis routine executed by the printing management apparatus 30 of the embodiment. The printing management apparatus 30 executes this routine, when receiving a signal representing transmission of the image data and the setting data on the input resolution and the output resolution from each printing device. When the program enters this print diagnosis routine, the printing management apparatus 30 of the embodiment first receives the image data obtained by reading the printing result of the test pattern image with the scanner, the setting data on the output resolution of the printing device for printing the test pattern image, and the setting data on the input resolution of the scanner for reading the test pattern image printed on the printing paper (step S300), and carries out a printing abnormality check process, based on the received image data and setting data on the input resolution and the output resolution (step S302). The printing abnormality check process follows the flowchart of FIG. 7.

When the printing abnormality check process starts, the printing management apparatus 30 of the embodiment first specifies a tolerance of deviation of the image data from the original data of the test pattern image, which is used as the standard in check for abnormality of printing, based on the setting data on the output resolution of the printing device and the setting data on the input resolution of the scanner (step S310). The tolerance of deviation is specified to prevent a false detection of abnormal printing, due to a difference between the information volume of the original data of the test pattern image and the information volume of the image data of the test pattern image that is printed according to the original data by the printing device and is read by the scanner.

When the output resolution (effective resolution) of the printing device and the input resolution of the corresponding scanner are set to be not less than a specific resolution level corresponding to a specific information volume equivalent to the information volume of the original data of the test pattern image (specifically, when the settings of both the output resolution of the printing device and the input resolution of the corresponding scanner are not less than the specific resolution level corresponding to the specific information volume equivalent to the information volume of the original data of the test pattern image), the information volume of the image data of the test pattern image printed by the printing device and read by the scanner is practically equal to the information volume of the original data of the test pattern image. In the normal printing state of the printing device, pixels constituting the image data of the test pattern image printed by the printing device and read by the corresponding scanner are substantially identical with pixels constituting the original data of the test pattern image. The normal printing state of the object printing device is thus detectable, based on the image data read by the scanner. On the other hand, when the output resolution of the printing device or the input resolution of the corresponding scanner is set to a certain resolution level corresponding to a certain information volume less than the information volume of the original data of the test pattern image (specifically, when the setting of the output resolution of the printing device is not less than the specific resolution level corresponding to the specific information volume equivalent to the information volume of the original data of the test pattern image but the setting of the input resolution of the corresponding scanner is the certain resolution level corresponding to the certain information volume less than the information volume of the original data of the test pattern image, when the setting of the input resolution of the scanner is not less than the specific resolution level corresponding to the specific information volume equivalent to the information volume of the original data of the test pattern image but the setting of the output resolution of the corresponding printing device is the certain resolution level corresponding to the certain information volume less than the information volume of the original data of the test pattern image, or when the settings of both the output resolution of the printing device and the input resolution of the corresponding scanner are the certain resolution level corresponding to the certain information volume less than the information volume of the original data of the test pattern image), the information volume of the image data of the test pattern image printed by the printing device and read by the corresponding scanner is less than the information volume of the original data of the test pattern image. Even in the normal printing state of the printing device, pixels constituting the image data of the test pattern image input by the corresponding scanner are not identical with pixels constituting the original data of the test pattern image. This may cause a false detection of abnormal printing by the printing device. Specifying the tolerance of deviation from the original data of the test pattern image as the standard according to the output resolution of the printing device and the input resolution of the corresponding scanner absorbs the difference in information volume between the original data of the test pattern image and the image data of the test pattern image printed by the printing device and read by the corresponding scanner. This arrangement thus ensures accurate print diagnosis of the printing device, based on the image data of the test pattern image read by the scanner.

After setting the tolerance of deviation for print diagnosis, it is determined whether the image data of the test pattern image input at step S300 is within the specified tolerance of deviation (step S312). When it is determined that the image data is within the tolerance of deviation, printing by the object printing device is determined as normal (step S314). When it is determined that the image data is out of the tolerance of deviation, on the other hand, printing by the object printing device is determined as abnormal (step S316). The program then exits from this printing abnormality check routine. The printing abnormality check process id described more with a concrete example of a test for clogging of nozzles in the printing device.

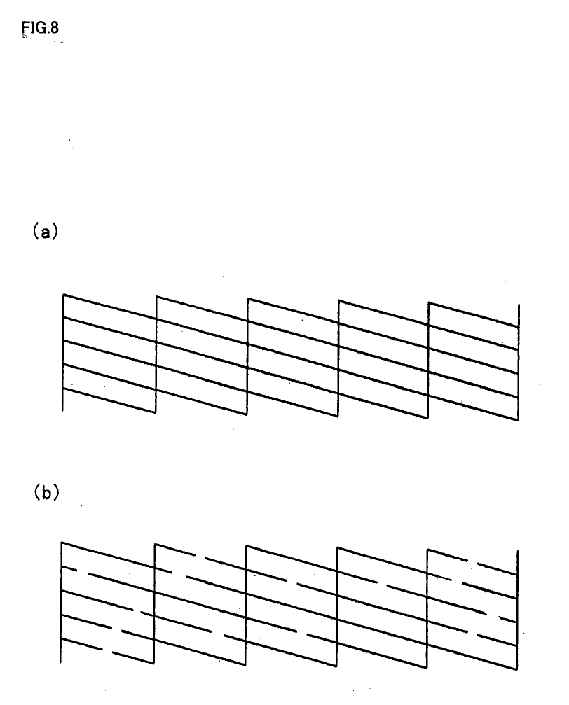

FIG. 8 shows an example of a nozzle clogging test pattern image used to test for clogging of nozzles in the printing device. In this illustrated example, when the test pattern printed by the object printing device has no blot or dropout but forms continuous lines as shown in FIG. 8(a), it is determined that nozzles have no clogging but are normal. When the printed test pattern has any blot or dropout as shown in FIG. 8(b), on the other hand, it is determined that nozzles have clogging and are abnormal. The image data are obtained by reading the nozzle clogging test pattern image, which is printed by the printing device, with the corresponding scanner. Pixels corresponding to the blot or the dropout of the printed test pattern image are not recognized as the pixels constituting the image data of the test pattern image read by the scanner. The image data of the test pattern image read by the scanner is thus inconsistent with the original data of the test pattern image. Clogging of the nozzles is thus detected in this case. When a difference of one pixel is specified as the tolerance of deviation from the original data of the test pattern image based on the output resolution of the printing device and the input resolution of the corresponding scanner, a discrepancy of one pixel is allowed. Printing by the object printing device 50a or 50b is accordingly determined as normal, unless there is a discrepancy of two or more consecutive pixels (that is, unless there are two or more consecutive pixels unrecognized as the test pattern). In the process of testing for clogging of nozzles, it is desirable to specify a greater tolerance of deviation with a decrease in information volume relative to the information volume of the original data of the test pattern image, that is, with a decrease in resolution. The tolerance of deviation may be set equal to 0, when high resolutions are required.

On conclusion of the printing abnormality check routine of FIG. 7, the program goes back to step S304 in the print diagnosis routine of FIG. 6. The object printing device is notified of the check result obtained by the printing abnormality check routine of FIG. 7 (step S304), and maintenance data (for example, data representing a fixation procedure corresponding to the place of abnormality) according to the check result is output to the jurisdiction management server 40 (step S306). The program then exits from this print diagnosis routine. The jurisdiction management server 40 receives the transmitted maintenance data and manages execution of maintenance by the expendable supply/maintenance organization with regard to the object printing device at the photo studio in the jurisdictional block, based on the received maintenance data.

As discussed above, when at least the preset time period has elapsed since the latest instruction for printing the test pattern image was given to each object printing device 50a or 50b connecting with the network 22, when at least the specified time period has elapsed with no execution of general printing by the object printing device 50a or 50b, or when the total paper consumption has reached at least the preset number of sheets after the latest printing execution date of the test pattern image with the object printing device 50a or 50b, the printing management apparatus 30 of the embodiment transmits a new instruction for printing the test pattern image to the object printing device 50a or 50b. The printing management apparatus 30 receives the image data of the test pattern image printed by the object printing device, which has received the instruction, and read by the corresponding scanner via the network 22 and compares the received image data with the original data of the test pattern image registered in the printing execution database 34 to check for abnormality of printing by the object printing device. This arrangement enables the printing management apparatus 30 to transmit the instruction for printing the test pattern image at an adequate timing and ensures auto check for the printing quality by the object printing device 50a or 50b. The printing management apparatus 30 notifies the object printing device of the check result, while outputting maintenance information corresponding to the check result to the jurisdiction management server 40 having jurisdiction over the object printing device, so as to take action adequate for the check result. The printing management apparatus 30 of the embodiment checks for abnormality of printing by each printing device 50a or 50b by taking into account the output resolution of the printing device 50a or 50b in the process of printing the test pattern image and the input resolution of the corresponding scanner 52a or 52b in the process of inputting the printing result of the test pattern image by the printing device 50a or 50b as image data. This arrangement effectively prevents a false detection of abnormal printing.

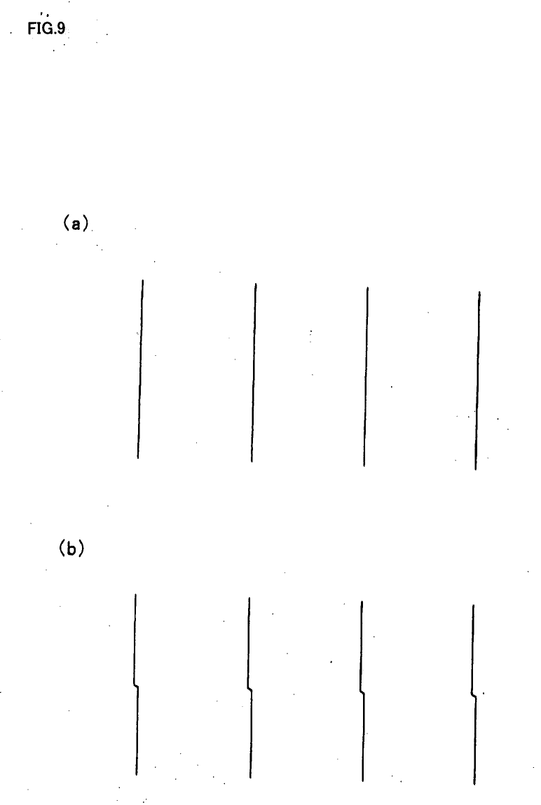

The printing management apparatus 30 of the embodiment performs the nozzle clogging test of each printing device 50a or 50b as one example of the print diagnosis. The printing management apparatus 30 may be used for other print diagnoses, for example, test for a deviation of the head position. FIG. 9 shows one example of a head position deviation test pattern image used to test for a deviation of the head position in the printing device. In this illustrated example, when each vertical line of the test pattern printed by the object printing device is aligned straight as shown in FIG. 9(a), it is determined that the head position has no deviation but is normal. When each vertical line of the printed test pattern is misaligned as shown in FIG. 9(b), on the other hand, it is determined that the head position has a deviation and is abnormal. The image data are obtained by reading the head position deviation test pattern image, which is printed by the printing device, with the corresponding scanner. In the case where pixels constituting the image data read by the scanner include pixels corresponding to the misalignment of each line in the test pattern image, the image data of the test pattern image input by the scanner is inconsistent with the original data of the test pattern image. A deviation of the head position is thus detected in this case. When a deviation of one pixel is specified as a tolerance based on the output resolution of the printing device and the input resolution of the corresponding scanner, a discrepancy of one pixel is allowed. When an adjoining pixel to the deviation is recognized as a constituent pixel of the test pattern image, printing by the object printing device is determined as normal. In the process of testing for a deviation of the head position, it is desirable to specify a greater tolerance with a decrease in information volume relative to the information volume of the original data of the test pattern image, that is, with a decrease in resolution. The tolerance may be set equal to 0, when high resolutions are required.

The printing management apparatus 30 of the embodiment specifies the tolerance based on the output resolution of the printing device and the input resolution of the scanner. When the printing device used is capable of printing the test pattern image with a sufficiently high resolution, the tolerance may be specified based on only the input resolution of the scanner. When the scanner used is capable of reading the test pattern image with a sufficiently high resolution, on the other hand, the tolerance may be specified based on only the output resolution of the printing device. No tolerance may be specified, when the printing device used is capable of printing the test pattern image with a sufficiently high resolution and the scanner used is capable of reading the test pattern image with a sufficiently high resolution.

The printing management apparatus 30 of the embodiment gives the instruction for printing the test pattern image to the corresponding printing device, based on the results of determination of whether at least the preset time period has elapsed since the ‘latest test printing instruction date’, determination of whether at least the specified time period has elapsed since the ‘latest printing execution date’, and determination of whether the ‘total paper consumption after the latest test printing execution date’ has reached at least the preset number of sheets. The instruction for printing the test pattern may alternatively be given, based on only one of such determination results or based on any combination of such determination results. Determination of whether the ‘total ink consumption after the latest test printing execution date’ has reached at least a preset quantity may be used in place of or in combination with the determination relating to the ‘total paper consumption after the latest test printing execution date’. The determination of whether at least the preset time period has elapsed since the ‘latest test printing instruction date’ may be replaced by determination of whether at least a predetermined time period has elapsed since the ‘latest test printing execution date’ or determination of whether at least a preset time period has elapsed since reception of the image data read by the scanner as the printing result of the test pattern image. The instruction for printing the test pattern image may be given, in response to reception of a request from the object printing device or in response to reception of a signal representing replacement of an ink cartridge from the object printing device. In the printing management apparatus 30 of the embodiment, the date is the unit of the criteria like the ‘latest test printing instruction date’, the ‘latest test printing execution date’, and the ‘latest printing execution date’. The unit of the criteria may be the week or the month. Another modified arrangement gives an instruction for cleaning the printing device (for example, cleaning the head), together with the instruction for printing the test pattern image and instructs the printing device to print the test pattern image on completion of the cleaning.

The printing management apparatus 30 of the embodiment notifies each object printing device of the check result for abnormality of printing by the printing device. One modified arrangement may output a print stop instruction to the object printing device according to the seriousness of the abnormality. This arrangement desirably prevents printing from being carried out by the printing device in the abnormal state.

In the structure of the embodiment, the jurisdiction management server 40 is located in each block and manages supplies of expendables to the printing devices 50a and 50b in the jurisdictional block as well as maintenance of the printing devices 50a and 50b by the expendable supply/maintenance organization. The printing management apparatus 30, in place of each jurisdiction management server, may alternatively consolidate the management.

The above description regards the printing management apparatus 30 in one embodiment of the invention. The invention may also be actualized by a printing management method or by a storage medium in which a program for causing a single or multiple computers to attain the functions of the printing management apparatus 30 is stored. In the latter application, the program is installed from the storage medium into a memory device of the computer and is executed appropriately to exert the effects of the printing management apparatus 30 discussed above.

The above embodiment embodiment is to be considered in all aspects as illustrative and not restrictive. There may be many modifications, changes, and alterations without departing from the scope or spirit of the main characteristics of the present invention. All changes within the meaning and range of equivalency of the claims are therefore intended to be embraced therein.

What is claimed is:

1. A printing management apparatus that is connected with multiple printing devices, each of which is used to print an image, via a network and manages said multiple printing devices through transmission of information via the network, said printing management apparatus comprising:
a memory unit that stores identification information on each of said multiple printing devices mapped to timing information on a timing of giving an instruction for printing a predetermined image to each of said multiple printing devices;
a printing instruction transmission module that transmits printing instruction information, which represents the instruction for printing the predetermined image, at a timing specified by a specific piece of the timing information stored in said memory unit via the network to an object printing device identified by a piece of the identification information mapped to the specific piece of the timing information;
a printing result reception module that receives a printing result, which is printed by said object printing device receiving the printing instruction information and is input by an image input device connecting with said object printing device, as image data via the network from said object printing device; and
an abnormality check module that checks for abnormality of printing by said object printing device, based on the received image data.

2. A printing management apparatus in accordance with claim 1, wherein said memory unit further stores original data of the predetermined image, and said abnormality check module checks for abnormality of printing, based on the received image data and the original data stored in said memory unit.

3. A printing management apparatus in accordance with claim 1, said printing management apparatus further comprising:
an output setting information reception module that receives output setting information on an output setting of said object printing device for printing the predetermined image via the network from said object printing device,
wherein said abnormality check module checks for abnormality of printing, based on the image data received by said printing result reception module and the output setting information received by said output setting information reception module.

4. A printing management apparatus in accordance with claim 3, said printing management apparatus further comprising:
a tolerance setting module that specifies a tolerance of deviation from original data of the predetermined image, based on the output setting information received by said output setting information reception module,
wherein said memory unit further stores the original data of the predetermined image, and
said abnormality check module determines whether the image data received by said printing result reception module is within the specified tolerance of deviation from the original data.

5. A printing management apparatus in accordance with claim 4, wherein the output setting information is information on setting of an output resolution.

6. A printing management apparatus in accordance with claim 1, said printing management apparatus further comprising:
an input setting information reception module that receives input setting information on an input setting of said image input device for inputting the predetermined image printed by said object printing device via the network from said object printing device,
wherein said abnormality check module checks for abnormality of printing, based on the image data received by said printing result reception module and the input setting information received by said input setting information reception module.

7. A printing management apparatus in accordance with claim 6, said printing management apparatus further comprising:
a tolerance setting module that specifies a tolerance of deviation from original data of the predetermined image, based on the input setting information received by said input setting information reception module,
wherein said memory unit further stores the original data of the predetermined image, and
said abnormality check module determines whether the image data received by said printing result reception module is within the specified tolerance of deviation from the original data.

8. A printing management apparatus in accordance with claim 7, wherein the input setting information is information on setting of an input resolution.

9. A printing management apparatus in accordance with claim 1, wherein said memory unit stores information including a reference time, which is updated at a preset timing, as the timing information, and
said printing instruction transmission module transmits the printing instruction information when a preset time period has elapsed since a latest reference time stored in said memory unit.

10. A printing management apparatus in accordance with claim 9, wherein said memory unit stores information including a latest time, when printing of the predetermined image was executed by said object printing device, as the timing information.

11. A printing management apparatus in accordance with claim 9, wherein said memory unit stores information including a latest time, when general printing was executed by said object printing device, as the timing information.

12. A printing management apparatus in accordance with claim 1, said printing management apparatus further comprising:
a use information reception module that receives use information on use of said object printing device, from said object printing device,
wherein said memory unit stores the received use information mapped to identification information of said object printing device, which has sent the use information, and
said printing instruction transmission module transmits the printing instruction information to said object printing device identified by the identification information, which is mapped to the use information and the timing information stored in said memory unit, based on the use information and the timing information.

13. A printing management apparatus in accordance with claim 12, wherein said memory unit stores information including a latest time, when printing of the predetermined image was executed by said object printing device, as the timing information, and
said use information reception module receives a total printing volume of said object printing device since the stored latest time as the use information.

14. A printing management apparatus in accordance with claim 13, wherein said printing instruction transmission module transmits the printing instruction information to said object printing device, when the total printing volume of said object printing device since the latest time stored in said memory unit has reached a preset level.

15. A printing management apparatus in accordance with claim 1, said printing management apparatus further comprising:
a check result notification module that notifies a result of the check carried out by said abnormality check module.

16. A printing management apparatus in accordance with claim 1, said printing management apparatus further comprising:
a maintenance instruction output module that outputs a maintenance instruction on maintenance of said object printing device, according to a result of the check for abnormality of printing by said printing device, which is carried out by said abnormality check module.

17. A printing management apparatus in accordance with claim 1, said printing management apparatus further comprising:
a stop instruction output module that outputs a stop instruction on a stop of printing to said object printing device, when said abnormality check module detects abnormality of said object printing device.

18. A printing management apparatus that is connected with multiple printing devices, each of which is used to print an image, via a network and manages said multiple printing devices through transmission of information via the network, said printing management apparatus comprising:
a printing instruction module that gives an instruction for printing a predetermined image to an object printing device;
a printing result acquisition module that acquires a printing result, which is printed by said object printing device receiving the instruction and is input by an image input device connecting with said object printing device, as image data from said object printing device; and
an abnormality check module that checks for abnormality of printing by said object printing device, based on the acquired image data.

19. A printing management apparatus in accordance with claim 18, wherein said abnormality check module checks for abnormality of printing, based on the acquired image data and original data of the predetermined image.

20. A printing management apparatus in accordance with claim 18, said printing management apparatus further comprising:
an output setting information acquisition module that acquires output setting information on an output setting of said object printing device for printing the predetermined image via the network from said object printing device,
wherein said abnormality check module checks for abnormality of printing, based on the image data acquired by said printing result acquisition module and the output setting information acquired by said output setting information acquisition module.

21. A printing management apparatus in accordance with claim 20, said printing management apparatus further comprising:
a tolerance setting module that specifies a tolerance of deviation from original data of the predetermined image, based on the output setting information acquired by said output setting information acquisition module,
wherein said abnormality check module determines whether the image data acquired by said printing result acquisition module is within the specified tolerance of deviation from the original data.

22. A printing management apparatus in accordance with claim 21, wherein the output setting information is information on setting of an output resolution.

23. A printing management apparatus in accordance with claim 18, said printing management apparatus further comprising:
an input setting information acquisition module that acquires input setting information on an input setting of said image input device for inputting the printing result of the predetermined image printed by said object printing device via the network from said object printing device,
wherein said abnormality check module checks for abnormality of printing, based on the image data acquired by said printing result acquisition module and the input setting information acquired by said input setting information acquisition module.

24. A printing management apparatus in accordance with claim 23, said printing management apparatus further comprising:
a tolerance setting module that specifies a tolerance of deviation from original data of the predetermined image, based on the input setting information acquired by said input setting information acquisition module,
wherein said abnormality check module determines whether the image data acquired by said printing result acquisition module is within the specified tolerance of deviation from the original data.

25. A printing management apparatus in accordance with claim 24, wherein the input setting information is information on setting of an input resolution.

26. A printing management method that manages multiple printing devices, each of which is used to print an image, through transmission of information to and from said multiple printing devices via a network, said printing management method comprising the steps of:
(a) storing identification information on each of said multiple printing devices mapped to timing information on a timing of giving an instruction for printing a predetermined image to each of said multiple printing devices into a memory unit, and transmitting printing instruction information, which represents the instruction for printing the predetermined image, at a timing specified by a specific piece of the timing information stored in said memory unit via the network to an object printing device identified by a piece of the identification information mapped to the specific piece of the timing information;
(b) receiving a printing result, which is printed by said object printing device receiving the printing instruction information and is input by an image input device connecting with said object printing device, as image data via the network from said object printing device; and
(c) checking for abnormality of printing by said object printing device, based on the received image data.

27. A printing management method that manages multiple printing devices, each of which is used to print an image, through transmission of information to and from said multiple printing devices via a network, said printing management method comprising the steps of:
(a) giving an instruction for printing a predetermined image to an object printing device;
(b) acquiring a printing result, which is printed by said object printing device receiving the instruction and is input by an image input device connecting with said object printing device, as image data from said object printing device; and
(c) checking for abnormality of printing by said object printing device, based on the acquired image data.

28. A storage medium in which a computer program is stored, said computer program being executed to manage multiple printing devices, each of which is used to print an image, through transmission of information to and from said multiple printing devices via a network, said computer program comprising:
(a) storing identification information on each of said multiple printing devices mapped to timing information on a timing of giving an instruction for printing a predetermined image to each of said multiple printing devices into a memory unit, and of transmitting printing instruction information, which represents the instruction for printing the predetermined image, at a timing specified by a specific piece of the timing information stored in said memory unit via the network to an object printing device identified by a piece of the identification information mapped to the specific piece of the timing information;
(b) a module of receiving a printing result, which is printed by said object printing device receiving the printing instruction information and is input by an image input device connecting with said object printing device, as image data via the network from said object printing device; and
(c) a module of checking for abnormality of printing by said object printing device, based on the received image data.

29. A storage medium in which a computer program is stored, said computer program being executed to manage multiple printing devices, each of which is used to print an image, through transmission of information to and from said multiple printing devices via a network, said computer program comprising:
(a) a module of giving an instruction for printing a predetermined image to an object printing device;
(b) a module of acquiring a printing result, which is printed by said object printing device receiving the instruction and is input by an image input device connecting with said object printing device, as image data from said object printing device; and
(c) a module of checking for abnormality of printing by said object printing device, based on the acquired image data.
